(19) United States
(12) Patent Application Publication
(10) Pub. No.: US 2010/0173018 A1
(43) Pub. Date: Jul. 8, 2010

(54) Microbicidal Compositions Including Activated Nitrogenous Compound and 1,4-Bis(Bromoacetoxy)-2-Butene, and Methods Of Using The Same

(75) Inventor: Deborah A. Marais, Lakeland, TN (US)

Correspondence Address: KILYK & BOWERSOX, P.L.L.C., 400 HOLIDAY COURT, SUITE 102, WARRENTON, VA, 20186, US

(73) Assignee: BUCKMAN LABORATORIES INTERNATIONAL, INC., Memphis, TN (US)

(21) Appl. No.: 12/633,844

(22) Filed: Dec. 9, 2009

Related U.S. Application Data
(60) Provisional application No. 61/143,180, filed on Jan. 8, 2009.

(51) Int. Cl. A01N 59/02; A01N 37/06; A01N 59/00

(52) U.S. Cl. 424/713; 514/549; 424/719; 424/722

(57) ABSTRACT

Microbicidal compositions for aqueous systems are provided that include (a) a nitrogenous compound activated by an oxidant or an enzyme and (b) 1,4-bis(bromoacetoxy)-2-butene (BBAB). The components are present in a combined amount synergistically effective to control the growth of at least one microorganism. Methods for controlling the growth of microorganisms in aqueous systems with the compositions are also provided.

This application claims the benefit under 35 U.S.C. §119(e) of prior U.S. Provisional Patent Application No. 61/143,180, filed Jan. 8, 2009, which is incorporated in its entirety by reference herein.

### BACKGROUND OF THE INVENTION

The present invention relates to compositions and methods to control the growth of microorganisms in aqueous systems. More particularly, the present invention relates to the treatment of aqueous systems with a synergistic mixture or combination of a nitrogenous compound activated with an oxidant or enzyme and 1,4-bis(bromoacetoxy)-2-butene.

Biocides have been used to eradicate or control microbial growth in different environments and industries. Depending on their mode of action and chemical characteristics, biocides are generally classified as either oxidizing or non-oxidizing; their successful application being dependent upon considering their deficiencies with relation to pH and/or temperature sensitivity, chemical sensitivity and/or compatibility, limited effectiveness, and environmental and/or toxicity. Biocides are used alone or in some cases, in combination with other biocides in efforts to maximize their antimicrobial effect.

Oxidizing biocides are commonly and widely used to control microbial populations. A typical criterion of using an oxidant to control microorganisms is to overcome the system oxidant “demand” in order to maintain an available oxidizer residual. Some industrial systems, especially those in the papermaking industry, have a considerable demand which would require the application of impractical amounts of oxidant to achieve microbiological control. In addition to the increased treatment costs associated with higher addition rates of oxidizing biocides, undesirable side effects of strong oxidizers, such as on the system and other process chemicals, can adversely affect both the system and the end product.

### SUMMARY OF THE INVENTION

A feature of this invention is to provide unique mixtures or combinations of a nitrogen containing compound activated with an oxidant or enzyme and 1,4-bis(bromoacetoxy)-2-butene that show synergistic activity against microorganisms in aqueous systems. Methods of synergistically controlling the growth of at least one microorganism in aqueous systems are also features of this invention.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention, in one embodiment, provides a microbicidal composition for aqueous systems comprising a nitrogenous compound activated by an oxidant or an enzyme and 1,4-bis(bromoacetoxy)-2-butene (BBAB), where the components are present in a combined amount synergistically effective to control the growth of at least one microorganism.

The present invention provides a method for controlling the growth of at least one microorganism by adding to an aqueous system a composition of the present invention in an amount synergistically effective to control the growth of the microorganism.

The present invention also embodies the separate addition of a nitrogenous compound activated by an oxidant or an enzyme and 1,4-bis(bromoacetoxy)-2-butene (BBAB) to an aqueous system. According to this embodiment, the components are individually added to the aqueous system so that the final amount of each component present at the time of use is that amount synergistically effective to control the growth of at least one microorganism. The components thus can be added simultaneously or separately to an aqueous system to provide a combination or mixture thereof in advance or in situ.

The compositions and methods of the present invention can be applied in a variety of aqueous systems and processes, industrial and non-industrial, including but not limited to, paper-making water systems, pulp slurries, white water in paper-making process, cooling water systems, waste water systems, recirculating water systems, hot tubs, swimming pools, recreational water systems, fresh water bodies, food processing systems, drinking water systems, leather-processing water systems, metal working fluids, textile treatment systems, and other industrial water systems. The aqueous systems also include additive aqueous systems, such as retention aids, sizing agents, defoamers, dry and wet strength additives and pigment slurries for pulp and paper systems.

The compositions of the present invention combine at least one nitrogen containing compound activated by an oxidant or an enzyme compound with BBAB to provide synergistic antimicrobial control as compared to the respective components used alone at the same concentrations. The synergistic effects resulting from the combination of a nitrogen containing compound activated by an oxidant or an enzyme compound with BBAB can provide microbial control at lower levels of the nitrogen containing compound activated by an oxidant or an enzyme, thereby avoiding or reducing possible adverse side effects associated with using higher concentrations of such oxidizing compounds in a system. Control of microbial populations in sulfite-containing aqueous systems can also be provided with the compositions combining or mixing a nitrogen containing compound activated by an oxidant or an enzyme compound and BBAB. The compositions of the present invention can provide potent antimicrobial efficacy in the presence of sulfite levels in an aqueous system which would retard antimicrobial properties of many conventional biocides and biocidal compositions that lack the biocide combination of the present invention.

It is to be understood that both the foregoing general description and the following detailed description are exemplary and explanatory only and are only intended to provide a further explanation of the present invention, as claimed. All patents, patent applications, and publications mentioned throughout the present application are incorporated in their entirety by reference herein.

### DETAILED DESCRIPTION OF THE PRESENT INVENTION

The present invention provides methods and compositions for controlling the growth of at least one microorganism in aqueous systems using combinations or mixtures of a nitrogenous compound activated by an oxidant or an enzyme and 1,4-bis(bromoacetoxy)-2-butene (BBAB), wherein the components are preferably present in a combined amount synergistically effective to control growth of at least one microorganism.

The synergistically effective amount can vary in accordance with the aqueous system, material or medium to be treated and can, for a particular application, be routinely determined by one skilled in the art in view of this disclosure. In various embodiments of the present invention, the synergistic effect provided by combining or mixing a nitrogenous compound activated by an oxidant or an enzyme and 1,4-bis(bromoacetoxy)-2-butene (BBAB) components can be shown, for example, by their combined use in controlling the growth of at least one microorganism at a Fractional Inhibitory Concentration Index (FIC) value of less than one (FIC<1). As used herein, synergy evaluation results expressed as “FIC” refers to synergy measured by checkerboards dilutions (Yan and Hancock, 2001), which is described in more detail in the examples herein.

The synergistic mixtures and combinations of the present invention can be introduced anywhere in an aqueous system where the two chemistries (BBAB and nitrogen containing compound activated by an oxidant and/or an enzyme compound) can be brought into close proximity or contact. These combinations can be provided, for example, by adding the chemistries by separate addition at separate feed points, by a concurrent feed system, or by a sequential feed system, provided that the two components have an opportunity to come into close proximity or contact with each other somewhere in the aqueous system.

As used herein, the term “aqueous system” includes, for example, recreational water systems, particularly recirculating water systems such as hot tubs, spas and swimming pools, and industrial fluid systems, including but not limited to, paper-making water systems, pulp slurries, white water in paper-making process, cooling water systems (cooling towers, intake cooling waters and effluent cooling waters), waste water systems (lagoons), food processing systems, drinking water systems, leather-processing water systems, metal working fluids, textile treatment systems, and other industrial water systems, and also fresh water bodies (ponds, lakes). The aqueous systems also include additive aqueous systems. An additive aqueous system is an aqueous system that is or will be added into a larger aqueous system. Such aqueous additive systems include, but are not limited to, retention aids, sizing agents, defoamers, dry and wet strength additives and pigment slurries, for pulp and paper systems.

As stated, the compositions of the present invention are useful in protecting various industrial water systems susceptible to attack by at least one microorganism. In various embodiments, the compositions of the present invention are useful in controlling at least one microorganism in aqueous systems of the pulp and paper industry, including, for example, providing an improved microbicide and preservative for aqueous system locations within a paper mill, such as a stock chest, whitewater loop, and other locations where the two chemistries can be brought into close proximity or contact.

According to the methods of the present invention, controlling or inhibiting the growth of at least one microorganism includes both the reduction and/or the prevention of such growth.

It is to be further understood that by “controlling” (e.g., preventing) the growth of at least one microorganism, the growth of the microorganism is at least partially inhibited. In other words, there is no growth or essentially no growth of the microorganism. “Controlling” the growth of at least one microorganism maintains the microorganism population at a desired level, reduces the population to a desired level (even to undetectable limits), and/or at least partially inhibits the growth of the microorganism. Thus, in one embodiment of the present invention, the systems susceptible to attack by the at least one microorganism are at least partially preserved from this attack and the resulting spoilage and other detrimental effects caused by the microorganism. Further, it is also to be understood that “controlling” the growth of at least one microorganism also includes biostatically reducing and/or maintaining a low level of at least one microorganism such that the attack by the microorganism and any resulting spoilage or other detrimental effects are mitigated, i.e., the microorganism growth rate or microorganism attack rate is slowed down and/or eliminated.

When two chemical microbicides are mixed and added to the product, or added separately, three results are possible:

1) The chemicals in the product would produce an additive (neutral) effect,

2) The chemicals in the product would produce an antagonistic effect, or

3) The chemicals in the product would produce a synergistic effect.

An additive effect has no economic advantage over the individual components. The antagonistic effect would produce a negative impact. Only a synergistic effect, which is less likely than either an additive or antagonistic effect, would produce a positive effect and therefore possess economic advantages.

It is known in the microbicidal literature that there is no theoretical method to anticipate additive, antagonistic, or synergistic effects when two biocides are mixed to yield a new formulation. Nor is there a method to predict the relative proportions of the different biocides required to produce one of the three effects described above.

The inventive microbicidal compositions combining a nitrogenous compound activated by an oxidant or an enzyme and 1,4-bis(bromoacetoxy)-2-butene (BBAB) demonstrate unexpected synergistic effects compared to the respective components alone used at similar concentrations. Thus, these compositions can achieve superior, i.e. greater than additive, microbicidal activity, even at low concentrations, against a wide variety of microorganisms. Examples of these microorganisms include fungi, bacteria, and/or algae, and/or mixtures thereof, such as, but not limited to, for example, Trichoderma viride, Aspergillus niger, Pseudomonas aeruginosa, Klebsiella pneumoniae, Ochrobactrum anthropi, and Chlorella sp. A further example is a gram-positive microorganism, like Bacillus species. The compositions of the present invention preferably have low toxicity.

Nitrogenous Compounds Activated with Oxidant or Enzyme

The nitrogenous compound(s) can be, for example, ammonia, an ammonium salt, an organic amine, sulfamic acid, or combinations thereof. Additional examples of nitrogenous compounds include methylamine, dimethylamine, ethanolamine, ethylenediamine, diethanolamine, triethanolamine, dodecylethanolamine, hexdecylethanolamine, oleic acid ethanolamine, triethylenetetramine, dibutylamine, tributylamine, glutamine, dilaurylamine, distearylamine, tallow-methylamine, coco-methylamine, n-acetylglucosamine, diphenylamine, ethanol/methylamine, diisopropanolamine, n-methylaniline, n-hexyl-n-methylamine, n-heptyl-n-methylamine, n-octyl-n-methylamine, n-nonyl-n-methylamine, n-decyl-n-methylamine, n-dodecyl-n-methylamine, n-tridecyl-n-methylamine, n-tetra-decyl-n-methylamine, n-benzyl-n-methylamine, n-phenylethyl-n-methylamine, n-phenylpropyl-n-methylamine, n-alkyl-n-ethylamines, n-alkyl-n-hydroxyethylamines, n-alkyl-n-propylamines, n-propylheptyl-n-methylamine, n-ethylhexyl-n-methylamine, n-ethylhexyl-n-butylamine, n-phenylethyl-n-methylamine, n-alkyl-n-hydroxypropylamines, n-alkyl-n-isopropylamines, n-alkyl-n-butylamines, n-alkyl-n-isobutylamines, n-alkyl-n-hydroxyalkylamines, hydrazine, urea, guanidines, biguanidines, polyamines, primary amines, secondary amines, cyclic amines, bicyclic amines, oligocyclic amines, aliphatic amines, aromatic amines, primary or secondary nitrogen containing polymers, and any combinations thereof. Examples of ammonium salts include, but are not limited to, ammonium bromide, ammonium carbonate, ammonium chloride, ammonium fluoride, ammonium hydroxide, ammonium iodide, ammonium nitrate, ammonium phosphate, and ammonium sulfamate. Preferred nitrogenous compounds are, for example, ammonium bromide and ammonium chloride.

The oxidants that can be used in conjunction with the nitrogenous compounds include, but are not limited to, chlorine, alkali and alkaline earth hypochlorite salts, hypochlorous acid, chlorinated isocyanurates, bromine, alkali and alkaline earth hypobromite salts, hypobromous acid, bromine chloride, halogenated hydantoins, ozone and peroxy compounds such as alkali and alkaline earth perborate salts, alkali and alkaline earth percarbonate salts, alkali and alkaline earth persulfate salts, hydrogen peroxide, percarboxylic acid, and peracetic acid.

The nitrogenous compound activated by an oxidant preferably can be monochloramine (MCA). The activated nitrogenous compound also preferably can be provided in which the nitrogenous compound is ammonium bromide and the oxidant is sodium hypochlorite. Other nitrogenous compounds activated with oxidants also can be used.

The enzymes that can be used for activation of the nitrogenous compounds include, but are not limited to, haloperoxidase, which include enzymes falling into the chloride peroxidase, bromide peroxidase and iodide peroxidase groups.

The nitrogenous compound that is activated by an oxidant or an enzyme can be prepared in advance or formed in situ in an aqueous system to be treated. For example, the nitrogenous compound can be preactivated by treatment with a suitable oxidant or enzyme, or, alternatively, an oxidizable nitrogenous compound and the oxidant or enzyme can be separately added to the aqueous system for in situ activation of the nitrogenous compound in the aqueous system.

### 1,4-bis(bromoacetoxy)-2-butene (BBAB)

1,4-bis(bromoacetoxy)-2-butene (BBAB) employed by the present invention has the following formula:

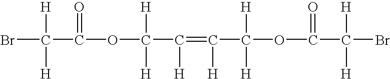

The synthesis of these compounds is described in U.S. Pat. No. 2,840,598, incorporated in its entirety by reference herein. The CAS No. for BBAB is 20679-58-7. BBAB has a molecular weight of 330 and is commercially available as a technical grade product from Bromine Compounds Ltd. In HPLC analysis, the technical grade of BBAB is about 87% BBAB, 4% 1-bromoacetoxy-4-dibromoacetoxy-2-butene (MBAB), and 4% of 1-bromoacetoxy-4-hydroxy-2-butene (BAHB). All of these compounds are active ingredients and are considered microbiocides. For purposes of the present invention, BBAB can include the presence of one or more of these other compounds in small quantities (e.g., 10% by weight or less).

The boiling point of BBAB is about 135° C.-136° C. at 0.005 mm Hg, and the freezing point of BBAB is below −20° C. The solubility of BBAB in water is extremely low. BBAB is soluble in dimethylformamide and ethylene glycol monomethylether. BBAB is also soluble in an isopropenol, n-butenol, glycerol, ethylene glycol, propylene glycol, and diethylene glycol. The specific gravity of the technical grade of BBAB is 1.74 at 20° C.

Because BBAB has a high specific gravity, it has a higher density than water which adds to the problem that BBAB does not disperse well into aqueous systems such as water. In other words, BBAB can be considered water insoluble.

Thus, in various embodiments, the BBAB component preferably is used in an emulsified composition to facilitate its dispersion or dissolution in an aqueous system. Emulsified compositions containing BBAB are available commercially, for example, under the product name BUSAN®1210 from Buckman Laboratories (Memphis, Tenn.).

The emulsified concentrated formulations of BBAB contain at least BBAB as an active ingredient. The emulsified formulation also preferably contains a nonionic emulsifier that has a molecular weight range of from about 500 to about 8,000, preferably from about 800 to about 7,000 and more preferably from about 1,000 to about 6,000; and/or an HLB value of from about 7 to about 24, preferably from about 10 to about 20, and more preferably from about 13 to about 18.

Preferably, the emulsified formulation of BBAB also preferably contains an epoxidized oil, a hydrophilic solvent, and/or an anionic emulsifier.

The BBAB is generally present in the emulsified formulation in a concentration sufficient to allow an active amount of BBAB to be introduced into an aqueous system in the co-presence of the nitrogenous compound activated with an oxidant or enzyme sufficient to provide synergistic control or inhibition of the growth of at least one microorganism. Preferably, the amount of BBAB present in the emulsified formulation is from about 80 wt % to about 90 wt %, and more preferably 82 wt % to about 87 wt %, and most preferably about 86 wt %. These weight percentages, as well as all other weight percentages referred to herein, are based on the total weight of the emulsified formulation.

The nonionic emulsifier can be present in the emulsified formulation in an amount from about 1 wt % to about 10 wt %, and more preferably about 5 wt %. Generally, non-ionic emulsifiers or surfactants prepared by reacting C₁-C₈ alcohols, preferably C₁-C₄ alcohols, with ethylene oxide and propylene oxide can be used. In lieu of the propylene oxide as one of the reactants, butylene oxide could be used or a mixture of propylene oxide with butylene oxide. Alternatively, nonyl phenol reacted with ethylene oxide and optionally with propylene oxide, butylene oxide, or mixtures thereof can also be a suitable non-ionic emulsifier for purposes of the present invention. One preferred nonionic emulsifier is butoxypolypropyleneoxypolyethyleneoxyethanol which has a molecular weight of 2990 or 3117 depending on the method of calculation, according to the manufacturing data. This compound is commercially available from Union Carbide (Danbury, Conn.) under the trade name TERGITOL XD. Other commercial products which could also be used as the nonionic emulsifier are TOXIMUL 8320 (a non-ionic alkoxylate), or 8322 from Stepan Co. (Northfield, Ill.), T DER XD and XH (an alkoxylated butyl alcohol) from Harcros Chemicals Inc. (Kansas City, Kans.), and MONOLAN 6400 (an ethylene oxide, propylene oxide-copolymer) from Henkel Corporation (Cinn., Ohio).

The anionic emulsifier preferably is a phosphate ester anionic emulsifier. This emulsifier preferably is used in sufficient amounts to improve the stability of BBAB in solution. Preferably, the anionic emulsifier is present in an amount ranging from about 0.5 wt % to about 5 wt %, and more preferably about 1.5 wt %. One preferred anionic emulsifier with a phosphate ester functional group is MONOFAX 785 (an alkoxyphosphate) which has an HLB value of about 10 to about 12 and is available from Mona Industries, Inc. (Patterson, N.J.). Other commercially available and acceptable phosphate ester anionic emulsifiers are T-MULZ 565, 598, 734, or 800 (an organo phosphonic acid ester) from Harcros Chemicals Inc. (Kansas City, Kans.), MAPHOS from Mazer Chemicals (Gurnee, Iowa), and ANTARA or GAFAC both from Rhone-Poulenc (Cranberry, N.J.). Another phosphate ester anionic emulsifier is EMPHOS PS-236 available from Witco Chemicals Corporation (New York, N.Y.).

The epoxidized oil should be compatible and inert to BBAB. It is also preferred that the epoxidized oil have a high density (i.e., greater than 1.0). Preferred epoxidized oils are epoxidized linseed oil and epoxidized soy bean oil. Generally, the epoxidized oil is present in an amount from about 1 wt % to about 10 wt %, and preferably about 5 wt %.

The hydrophilic solvent preferably has strong coupling ability and is preferably dipropylene glycol methylether. The amount of the hydrophilic solvent is preferably from about 1.0 wt % to about 5.0 wt %, and more preferably about 1.5 wt %. One function of the hydrophilic solvent is to reduce the chance of crystallization of BBAB at room or lower temperatures during storage.

Another preferred component in the emulsion composition for BBAB is an antioxidation agent such as butylated hydroxyanisole (“BHA”) or butylated hydroxytoluene (“BHT”). Other acceptable antioxidation agents are tocopherol, propyl gallate, t-butyl hydroquinone, and di-t-butylhydroquinone. All of these antioxidation agents also have the ability to improve the stability of the overall formulation. Preferred amounts of the antioxidation agent are from about 0.1 wt % to about 5.0 wt %, and more preferably about 1.0 wt %.

One preferred emulsion formulation for BBAB is Formula A as follows: (a) 86.0 wt % technical grade BBAB (includes 4% MBAB and 4% BHAB), (b) 5.0 wt % epoxidized linseed oil, (c) 5.0 wt % TERGITOL XD, 1.5 wt % MONOFAX 785, 1.5 wt % dipropylene glycol methylether, and 1.0 wt % butylated hydroxyanisole.

When lower amounts of the active ingredient are present in the emulsion, such as amounts ranging from about 25.0 wt % to about 50.0 wt % of BBAB, the amount of the components that are preferred can change. In particular, with this range of BBAB, it is preferred to have the nonionic emulsifier, preferably TERGITOL XD, present in an amount from about 5 wt % to about 15 wt %, and more preferably about 10 wt %. The anionic emulsifier, preferably MONOFAX 785, is preferably present in an amount from about 1.0 wt % to about 5 wt %, and more preferably about 3.0 wt %. Instead of a hydrophilic solvent, a hydrophobic solvent is used, preferably DMATO (dimethylamide of tall oil fatty acid), which is preferably present in an amount from about 10 wt % to about 45 wt %, and more preferably about 35 wt %. Other examples of hydrophobic solvents are aromatic solvents.

An epoxidized oil is preferably used, and most preferably, an epoxidized oil with about 15 wt % mineral oil. The epoxidized oil is preferably present in an amount from about 5 wt % to about 10 wt %, and more preferably about 7.5 wt %. When no mineral oil is used, the epoxidized oil is preferably present in an amount from about 10 wt % to about 25 wt %, and more preferably about 16.5 wt %.

The antioxidation agent, which is preferably BHA or BHT, can be present in the same amounts as described above or other amounts.

Generally, in making the emulsion formulation for BBAB, the above described ingredients can be mixed together to form the emulsion formulation for BBAB. The emulsion formulation facilitates the use of the active ingredient, BBAB, in aqueous environments. In other words, the emulsion formulation for BBAB has the ability to disperse and/or dissolve in aqueous solutions, such as water. This is an important feature in controlling or inhibiting the growth of microorganisms which are present in aqueous systems. A formulation that does not disperse or dissolve in aqueous systems simply would not be proficient in controlling or inhibiting the growth of at least one microorganism and thus the emulsion formulation for BBAB has the ability to be effective together with the activated nitrogenous compound in such aqueous systems due to its ability to disperse or dissolve in aqueous systems such as water.

The emulsion formulation for BBAB can also be further diluted by simply taking the formulation and diluting it with the appropriate amount of water to create the necessary wt % of the active ingredient for whatever need is called for. Again, a formulation that would not be so easily diluted would not be desirable in commercial applications where industry demands that a product be sold in concentrate form and then diluted at the site of use. The emulsion formulation for BBAB provides this advantage as well.

The combination of BBAB and nitrogenous compound activated with an oxidant or enzyme can be used alone, or optionally in combination with additional chemicals, such as additional microbicidal components, depending upon the intended use of the application.

The weight ratio of the activated nitrogenous compound to BBAB (active) used in compositions and mixtures of the present invention can be from about 1:0.5 to about 1:133, and preferably from about 1:0.7 to about 1:100, and more preferably about 1:2.5 to about 1:40, depending on the particular combination of components. Other ratios may be used. As indicated, the synergistically effective amount varies in accordance with the aqueous system to be treated, and which can be routinely determined for a particular application by one skilled in the art in view of this disclosure.

### Optional Additives

Optional components for the compositions of the present invention can include additives for the microbicidal compositions and/or process chemicals used in the aqueous system undergoing treatment. Optional additives for the microbicidal composition include, for example, one or more of non-oxidizing biocides, preservatives, emulsifiers, surfactants, buffers, pH modifiers, and other chemical additives. These optional additives can be used in effective amounts for their intended purpose provided they do not inhibit or otherwise interfere with the performance of the base composition. For example, additional non-oxidizing biocides optionally can be used in effective amounts to intensify, expand or tailor antimicrobial effects shown by the base composition comprising the activated nitrogenous compound and BBAB. Examples of optional non-oxidizing biocides that can be included in compositions of the present invention, but are not limited to, aldehydes, formaldehyde releasing compounds, halogenated hydrocarbons, phenolics, amides, halogenated amides, carbamates, heterocyclic compounds containing nitrogen and sulfur atoms in the ring structure, electrophilic active substances having an activated halogen group in the α-position and/or in the vinyl position to an electronegative group, nucleophilic active substance having an alkyl group and at least one leaving group, and surface active agents. Examples of these optional non-oxidizing biocides can be found, for example, in U.S. Pat. No. 7,008,545 B2, which teachings are hereby incorporated in their entirety herein by reference. The usage amount of non-oxidizing biocide, if included, can depend on the specific chemical selected.

### Treatments and Processes

The biocidal mixtures or methods of this invention are effective for controlling and inhibiting the growth and reproduction of microorganisms in aqueous systems. Aqueous systems include the industrial and non-industrial aqueous systems such as mentioned previously herein. The aqueous systems include additive aqueous systems. In addition, the aqueous systems in which the present invention can be used includes, but is not limited to, those involved in, paints, leather, wood, wood pulp, wood chips, starch, clays, retention aids, sizing agents, defoamers, dry and wet strength additives, pigment slurries (e.g., precipitated calcium carbonate), proteinaceous materials, lumber, animal hides, vegetable tanning liquors, cosmetics, toiletry formulations, emulsions, adhesives, coatings, metalworking fluids, swimming pool water, textiles, heat exchangers, pharmaceutical formulations, geological drilling lubricants, and agrochemical compositions.

The compositions combining or mixing a nitrogen containing compound activated by an oxidant or an enzyme compounds and BBAB also can provide potent antimicrobial efficacy in the presence of sulfite levels in an aqueous system which would retard antimicrobial properties of many conventional biocides and biocidal compositions that lack the biocide combination of the present invention. In various embodiments, the compositions of the present invention are used to treat aqueous systems containing sulfite or sulfites at a total concentration greater than about 0.1 ppm by weight based on the weight of the aqueous system being treated. The compositions of the present invention can control microbial populations in an aqueous system even in the presence of increased levels of sulfites.

The activated nitrogenous compound and BBAB biocides can be added to the aqueous system as independent material(s), or in combination with each other and/or with other materials being added to the aqueous system being treated. For example, either or both of the biocides can be added with one or more of starch, clay, pigment slurries, precipitated calcium carbonate, retention aids, sizing aids, dry and/or wet strength additives, defoamers or other additives used in the manufacturing of pulp or paper products.

The dosage amounts of the nitrogenous compounds activated with oxidants or enzymes and BBAB required for effectiveness in compositions of this invention generally depend, for example, on the nature of the aqueous system being treated, the level of organisms present in the aqueous system, and the level of inhibition desired. As indicated, a person skilled in the art could determine the amount necessary without undue experimentation in view of this disclosure. For example, one of ordinary skill can readily determine the effective amount required for a particular application by testing various combinations of concentrations of the activated nitrogenous compound and BBAB on one or more target microorganisms prior to treatment of the entire effected system.

In general, the effective concentrations of BBAB, on an active level basis, can be from about 1.0 parts per million (ppm) to about 35 ppm by weight, (i.e., based on the weight of aqueous system being treated), and preferably from about 2.0 ppm to about 22 ppm, and the amount of the selected nitrogenous compound activated with oxidant or enzyme used in the synergistic combination with BBAB can depend on the specific chemical used. In general, the amount of the activated nitrogenous compound, on an active level basis, is from about 0.2 ppm to about 4 ppm based on the weight of aqueous system being treated, and preferably from about 0.5 ppm to about 2 ppm. For treatment in the stock chest of a pulp preparation and papermaking system, effective concentrations of BBAB, on an active level basis, can be from about 2.0 parts per million (ppm) to about 40 ppm by weight, (i.e., based on the weight of aqueous system being treated), and preferably from about 5 ppm to about 25 ppm, and the amount of the activated nitrogenous compound, on an active level basis, is from about 0.3 ppm to about 5.0 ppm based on the weight of aqueous system being treated, and preferably from about 0.5 ppm to about 2.0 ppm. For treatment in a white water loop of a pulp preparation and papermaking system, effective concentrations of BBAB, on an active level basis, can be from about 1.0 parts per million (ppm) to about 40 ppm by weight, (i.e., based on the weight of aqueous system being treated), and preferably from about 2.0 ppm to about 24 ppm, and the amount of the activated nitrogenous compound, on an active level basis, is from about 0.3 ppm to about 4.0 ppm based on the weight of aqueous system being treated, and preferably from about 0.5 ppm to about 2.0 ppm. Other concentrations may be used. Thus, with respect to the biocides, the lower and upper limits of the required concentrations can depend upon the specific biocide or combination of biocides used.

As an example, the parts per million of the nitrogen-containing compound can be from about 5 ppm to about 20 ppm and more preferably from about 7 ppm to about 15 ppm in combination with a ppm amount of BBAB of from about 10 ppm to about 50 ppm and more preferably from about 15 ppm to about 45 ppm and more preferably from about 20 ppm to about 40 ppm of BBAB. These combinations of ppm amounts provide synergistic results with respect to the percent inhibition of at least one microorganism.

The nitrogenous compound activated with an oxidant or enzyme can be added to the aqueous system before the BBAB and/or the BBAB can be added before the nitrogenous compound activated with an oxidant or enzyme or they can be added simultaneously. Their order of addition is not particularly limited. Optional additives, such as additional biocides or preservatives, can be added simultaneously with either the nitrogenous compound activated with oxygen or enzyme or BBAB, or both, or can be added to the aqueous system at a different time and/or location relative to both those components.

The nitrogenous compound activated with an oxidant can be added pursuant to any known method that provides the desired concentration of the nitrogenous compound activated with an oxidant in the aqueous system. Similar to the nitrogenous compound activated with an oxidant addition, in various embodiments, the BBAB can be added pursuant to any known method that provides the desired concentration of the nitrogenous compound activated with an oxidant in the aqueous system. Either or both nitrogenous compound activated with the oxidant or enzyme and BBAB can be feed continuously, intermittently, or alternately to aqueous systems.

The activated nitrogenous compound and BBAB biocides can be continuously, intermittently, or alternately added to aqueous and/or additive systems. The above feed strategies for biocide addition is dependent on the growth of the microbial population, the type of problematic microorganisms and the degree of surface fouling in a particular system. For example, ammonium bromide activated with an oxidant can be added to a system on a continuous basis while the BBAB is added on an intermittent basis or introduced from the treatment of additive systems (i.e., starch makedown solutions, retention aid makedown solutions, precipitated calcium carbonate slurries, etc.) or other feed points within the aqueous system (i.e., short or long loop, broke chest, saveall, thick stock, blend chest, head box).

The formulation of the present invention containing a nitrogenous compound activated with oxidant or enzyme with BBAB is an effective preservative against bacteria and fungi in commonly used paper additives and coating materials, such as, but not limited to, clay, starch, calcium carbonate, titanium dioxide, carboxymethyl cellulose, hydroxyethyl cellulose, acrylic latex, cationic acrylamide polymers, anionic polyacrylamide polymers, alum, styrene-butadiene resins, and various other polymers. Based on the ability of the formulation containing the nitrogenous compound activated with oxidant or enzyme and BBAB being effective against microorganisms in these pulp slurry and paper additives and coating materials, it is clear that this composition is an effective preservative for an entire host of substrates and commercial, industrial, agricultural, and wood products. Specific additional systems that can be treated include, for example, water-based paints and metalworking fluids, non-pharmaceutical grade water, and liquids contained in a water cooling device.

The synergistic activity of the combinations described above has been confirmed using standard laboratory techniques as illustrated below. The following examples are intended to illustrate, not limit, the present invention. In the following examples, all parts are proportions by weight unless otherwise specified.

### EXAMPLES

### General Procedures

A. Evaluation of Bactericidal Activity. This test method provides a technique for testing compounds for their effectiveness to control bacterial growth. MIC values represent the Minimum Inhibitory Concentration, defined as the lowest level of compound required to produce a 90% kill of a given organism.

### Apparatus:

Test tubes, 18-150 mm. Sterilized test tubes are required.

Incubator, capable of a maintaining a temperature of 37° C. (±1° C.).

Analytical balance, sensitive to 0.001 g

Autoclave

Vitek Biomerieu Bactometer

Bactometer Disposable Modules

Eppendorf micropipetor 1-200 ul and tips

Eppendorf repeator Plus and 0.5-1 ml tips

McFarland Standard #1

### Reagents and Materials:

Nutrient plate

NaCl

TRIZMA® (Tris) HCl

TRIZMA® (Tris) Base

Glucose

Peptone

Ammonium nitrate

Magnesium sulfate heptahydrate

Calcium chloride

BIOMERIEUX general purpose media (GPM)

Polysorbate (TWEEN) 80

Sodium Thiosulfate

Monopotassium phosphate

Dipotassium phosphate

Bromocresol purple

Sterile buffered 0.85% saline solution

### Media Preparation:

Basal Salts Substrate

| | | |
|---|---|---|
| TRIZMA ® (Tris) HCl | 3.9 | g |
| TRIZMA ® (Tris) Base | 0.05 | g |
| Glucose | 0.02 | g |
| Peptone | 0.01 | g |
| Ammonium nitrate | 1.00 | g |
| Magnesium sulfate heptahydrate | 0.25 | g |
| Calcium chloride | 0.25 | g |
| Deionized water | 1 | liter |

Modified Wilkins Chalaren Broth (Bactometer Media)

| | | |
|---|---|---|
| TRIZMA ® (Tris) HCl | 6.6 | g |
| TRIZMA ® (Tris) Base | 0.97 | g |
| BIOMERIEUX GPM | 33.0 | g |
| Lecithin | 3.0 | g |
| Polysorbate | 30.0 | g |
| Sodium thiosulfate | 5.0 | g |
| Sodium bisulfite | 1.0 | g |
| Monopotassium phosphate | 1.0 | g |
| Dipotassium phosphate | 1.0 | g |
| Bromocresol purple | 0.02 | g |
| Deionized water | 1 | liter |

### Test Inoculum.

Cell suspension from an 18 to 24 hour bacterial culture of Staphylococcus aureus (ATCC 6538) or Bacillus subtilis (ATCC 6633) or Enterobacter aerogenes (ATCC 13048) to attain a desired cell concentration. Using a McFarland nephelometer barium sulfate standard or some other suitable method, adjust the concentration of the bacterial suspension so that a final concentration of between 1×10⁴ and 1×10⁵ cells per ml is achieved when 100 μl of the inoculum is added to 5 ml of basal salts substrate.

### Procedure:

Sterilize the medium in the autoclave for 20 minutes at 15 pounds pressure (121° C.). After autoclaving, cool medium to 45-50° C. and dispense 5 ml of Basal Salts Substrate medium per test tube, then add the compound and the inoculum.

### Compound Incorporation:

Prepare a stock solution in water of the compound to be tested. The concentration of the stock solution is dependent on the largest dosage desired to be tested. Dilute the stock solution to obtain dosages smaller than that chosen for the stock solution. A maximum amount of 100 microliters of stock solution or the corresponding dilution should be added per test tube.

### Inoculation:

Add 100 ul of inoculum per test tube, per type of medium and type of inoculum.

### Incubation:

Place the test tubes containing the treatments in an incubator set at 37° C. for 18 hours.

### Rating of Tubes via Impedance Method:

Bacterial growth in the tubes is measured by monitoring impedance levels on the Bactometer.
Dispense 1 ml aliquots of Modified WILKINS Chalgren Broth (Bactometer Media) into Bactometer wells; add 25 μl of treatment from the incubated tubes. Place module in Bactometer and measure impedance for 6 hours. The Bactometer has been calibrated to convert impedance values to CFU (colony forming units)/ml

% Kill=Average CFU/ml in controls−Average CFU/ml in treatment×100 Average CFU/ml in controls

### Synergy Evaluation:

Synergy was measured by checkerboards dilutions (Yan and Hancock, 2001), in which one compound is diluted along the rows of test tubes and the other is diluted along the columns. This method focuses on looking for a reduction in the MIC of each component in the presence of the other. The result is expressed as the Fractional Inhibitory Concentration Index (FIC), calculated as follows:

FIC=[A]/MIC_{A}+[B]/MIC_{B} where,

MIC_{A} and MIC_{B}=MICs of the compounds A and B alone,

[A] and [B]=MICs of the compounds A and B when in combination.

An FIC index <1 indicates synergy; an index of 0.5 represents the equivalent of a fourfold decrease in the MIC of each compound in combination. An FIC index of 1.0 represents additive activity (a twofold decrease in the MIC of each compound in combination), and an index >1 indicates antagonism; an index >4 represents true antagonism.

### Example 1

Combinations of ammonium sulfate in the form of BUSPERSE 2454 from Buckman Laboratories (Memphis, Tenn.)., as a nitrogenous compound activated with oxidant (Activated N-Compound), and 1,4-bis(bromoacetoxy)-2-butene (BBAB). Amounts of nitrogenous compound activated with oxidant shown in Table 1 are based on active ingredient alone. BBAB was introduced in emulsion form as BUSAN®1210 from Buckman Laboratories (Memphis, Tenn.). Amounts of BBAB in Table 1 are based on BBAB active ingredient alone, and not the entire emulsion amount. The organism tested was Enterobacter aerogenes (ATCC 13048). The incubation period was 18 hours at 37° C.

TABLE 1

| Activated | | | | |
|---|---|---|---|---|
| N-Compound | BBAB | | | [A]/MIC_{A} + |
| [A] | [B] | [A]/MIC_{A} | [B]/MIC_{B} | [B]/MIC_{B} |
| 0 | 40 (MIC_{B}) | 0 | 1.0 | 1.0 |
| 0.30 | 24 | 0.06 | 0.6 | 0.66 |
| 0.5 | 16 | 0.1 | 0.4 | 0.5 |
| 1.0 | 16 | 0.2 | 0.4 | 0.6 |
| 2.0 | 4 | 0.4 | 0.1 | 0.5 |
| 3.0 | 1.6 | 0.6 | 0.04 | 0.64 |
| 5.0 (MIC_{A}) | 0 | 1.0 | 0 | 1.0 |

MIC_{A} = MIC of activated N-compound alone = 5.0 mg./l
MIC_{B} = MIC of BBAB alone = 40 mg./l
[A] = MIC of activated N-compound in combination with BBAB alone (mg./l)
[B] = MIC of BBAB alone in combination with BBAB (mg./l)
*= A value <1 denotes synergistic activity of both components used simultaneously.

### Example 2

Synergism in the presence of sulfite. The effectiveness of the actives and the blend were evaluated in a white water (ww) sample with a sulfite content of 12.8 ppm. ATP measurements were performed in duplicate and percent inhibition calculated as a measure of antimicrobial efficacy. The raw data was converted to percent inhibition with use of the following formulation:

% Inhibition=[(u−t)/u]×100

where:
u=ATP value of untreated ww at time_{10 min}
t=ATP value of treated ww at time_{10 min}.

The data in Table 2 demonstrates the synergistic activity of the compounds using a 20 minute delay between additions and a 10 min incubation time before the measurement of ATP values.

TABLE 2

| Activated | | |
|---|---|---|
| N-Compound | BBAB | |
| [ppm active] | [ppm active] | % Inhibition |
| 0 | 80 | 22.8 |
| 10 | 32 | 82.7 |
| 10 | 0 | 47.0 |
| 20 | 0 | 69.2 |
| 30 | 0 | 77.7 |

### Example 3

Synergy evaluation against filamentous bacteria. The checkerboard method was used to determine the Fractional Inhibitory Index (FIC) as a predictor of synergy between Activated N-Compound and Busan 1210 (BBAB) against a pure isolate of filamentous bacteria cultured from a paper mill slime deposit. The isolate was identified by 16 S ribosomal RNA sequencing technique. Gene assembly and data analysis was performed using MicroSeq data analysis and identification software; the isolate was identified as a Flectobacillus species.

Modified Basal Salts Buffer was inoculated with a suspension of the bacterial isolate to yield a final concentration of 1×10⁵ cells per ml. Using a delay between additions, Busan 1210 (BBAB) was added 20 minutes prior to the addition of monochloramine (MCA). After a 3 hours exposure time, the treatments were sub-cultured onto Nutrient and Plate Count Agar (PCA) and incubated at 28° C. for 48 hours. The plates were examined for colony forming units (CFU) and compared to untreated control.

$$\% Kill = \frac{C F U Control - C F U test}{C F U Control} \times 100$$

Synergy is expressed as a Fractional inhibitory Concentration Index (FIC), calculated as follows:

FIC=[A]/[a]+[B]/[b] where,

[A] and [B]=MIC of the compounds A and B when in combination

[a] and [b]=MIC of the compounds A and B when alone

| MCA | Busan 1210 | | | |
|---|---|---|---|---|
| A | B | A/a | B/b | FIC |
| 0 | 100 (b) | 0 | 1 | 1.0 |
| 1.0 | 50 | 0.1 | 0.5 | 0.6 |
| 1.0 | 30 | 0.1 | 0.3 | 0.4 |
| 1.0 | 10 | 0.1 | 0.1 | 0.2 |
| 3.0 | n5 | 0.3 | 0.05 | 0.35 |
| 5.0 | n5 | 0.5 | 0.05 | 0.55 |
| 10.0(a) | n0 | 1 | 0 | 1.0 |

As can be seen from the above results, the combination of a nitrogenous compound activated by an oxidant or an enzyme in combination with a BBAB biocide provides synergistic results and results in the ability to control the growth of at least one microorganism at a FIC value of less than 1.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for controlling the growth of at least one microorganism in an aqueous system comprising adding (a) a nitrogenous compound activated by an oxidant or an enzyme, and (b) 1,4-bis(bromoacetoxy)-2-butene to an aqueous system, wherein components (a) and (b) are added to the aqueous system in a microbicidally effective combined amount to control the growth of at least one microorganism at a Fractional Inhibitory Concentration Index (FIC) value of less than one.

2. The method of claim 1, wherein the aqueous system comprises sulfite at a concentration greater than about 0.1 ppm by weight based on the weight of the aqueous system being treated.

3. The method of claim 1, wherein said nitrogenous compound is ammonia, an ammonium salt, an organic amine, sulfamic acid, or combinations thereof.

4. The method of claim 1, wherein said nitrogenous compound is activated by an oxidant, wherein the oxidant is chlorine, alkali or alkaline earth hypochlorite salts, hypochlorous acid, chlorinated isocyanurates, bromine, alkali or alkaline earth hypobromite salts, hypobromous acid, bromine chloride, halogenated hydantoins, ozone, a peroxy compound, or combinations thereof.

5. The method of claim 1, wherein said nitrogenous compound activated by said oxidant or said enzyme comprises monochloramine.

6. The method of claim 1, wherein said nitrogenous compound is activated by said enzyme, and said enzyme is a haloperoxidase.

7. The method of claim 1, wherein the adding of the nitrogenous compound is activated by said oxidant or said enzyme comprises either: 1) adding to the aqueous system said nitrogenous compound that has been preactivated by treatment with said oxidant or said enzyme, or 2) adding an oxidizable nitrogenous compound and separately the oxidant or enzyme to the aqueous system for in situ activation of said nitrogenous compound in the aqueous system.

8. The method of claim 1, further comprising adding at least one non-oxidizing biocide to said aqueous system.

9. The method of claim 8, wherein said at least one non-oxidizing biocide is an aldehyde, formaldehyde releasing compound, halogenated hydrocarbon, phenolic, amide, carbamate, heterocyclic compound containing nitrogen and sulfur atoms in the ring structure, electrophilic active substance having an activated halogen group in the α-position and/or in the vinyl position to an electronegative group, nucleophilic active substance having an alkyl group and at least one leaving group, or surface active agent.

10. The method of claim 1, further comprising adding said 1,4-bis(bromoacetoxy)-2-butene in the form of an emulsion comprising about 80 wt. % to about 90 wt. % of said 1,4-bis(bromoacetoxy)-2-butene and about 1 wt % to about 10 wt % of a nonionic emulsifier having a molecular weight of from about 500 to about 8,000 and a HLB value of from about 7 to about 20.

11. The method of claim 1, wherein said activated nitrogenous compound is added in an amount that ranges from about 0.2 to about 4 parts per million (ppm) by weight based on the weight of the aqueous system being treated, and said 1,4-bis(bromoacetoxy)-2-butene, on an active level is added in an amount that ranges from about 1 to about 35 ppm by weight based on the weight of the aqueous system being treated.

12. The method of claim 1, wherein said nitrogenous compound and said 1,4-bis(bromoacetoxy)-2-butene are added separately to the aqueous system.

13. The method of claim 1, wherein said nitrogenous compound and said 1,4-bis(bromoacetoxy)-2-butene are added simultaneously to the aqueous system.

14. The method of claim 1, wherein said at least one microorganism is a bacterium or fungus.

15. The method of claim 1, wherein the aqueous system comprises an industrial water system.

16. The method of claim 1, wherein the aqueous system is a pulp slurry, a paper mill whitewater, a cooling water system, an industrial lagoon, a lake, a pond, a swimming pool, a leather water treatment system, or a textile treatment system.

17. A composition comprising (a) a nitrogenous compound activated by an oxidant or an enzyme, and (b) 1,4-bis(bromoacetoxy)-2-butene, wherein components (a) and (b) are present in a microbicidally effective combined amount to control the growth of at least one microorganism at a Fractional Inhibitory Concentration Index (FIC) value of less than one.

18. The composition of claim 17, wherein said nitrogenous compound is ammonia, an ammonium salt, an organic amine, sulfamic acid, or combinations thereof.

19. The composition of claim 17, wherein said nitrogenous compound is activated by an oxidant, wherein the oxidant is chlorine, alkali or alkaline earth hypochlorite salts, hypochlorous acid, chlorinated isocyanurates, bromine, alkali or alkaline earth hypobromite salts, hypobromous acid, bromine chloride, halogenated hydantoins, ozone, a peroxy compound, or combinations thereof.

20. The composition of claim 17, wherein said nitrogenous compound activated by said oxidant or said enzyme comprises monochloramine.

21. The composition of claim 17, wherein said nitrogenous compound is activated by said enzyme, and said enzyme is a haloperoxidase.

22. The composition of claim 17, further comprising adding at least one non-oxidizing biocide to said aqueous system.

23. The composition of claim 17, wherein said activated nitrogenous compound and said 1,4-bis(bromoacetoxy)-2-butene, on an active level are present in a weight ratio of about 1:0.5 to about 1:133.
